(19) United States
(12) Patent Application Publication
(10) Pub. No.: US 2001/0034788 A1
(43) Pub. Date: Oct. 25, 2001

(54) System and method for receiving packet data multicast in sequential looping fashion

(76) Inventors: Brennan J. McTernan, Fanwood, NJ (US); Adam Nemitoff, Ridgewood, NJ (US); Altay Murat, Richmond Hill, NY (US)

Correspondence Address: Brown Raysman Millstein FELDER & STEINER, LLP, 900 THIRD AVENUE, New York, NY, 10036, US

(21) Appl. No.: 09/767,604

(22) Filed: Jan. 22, 2001

Related U.S. Application Data
(60) Provisional application No. 60/177,397, filed on Jan. 21, 2000.
(60) Provisional application No. 60/177,394, filed on Jan. 21, 2000.
(60) Provisional application No. 60/177,396, filed on Jan. 21, 2000.
(60) Provisional application No. 60/177,395, filed on Jan. 21, 2000.
(60) Provisional application No. 60/177,398, filed on Jan. 21, 2000.
(60) Provisional application No. 60/177,399, filed on Jan. 21, 2000.
(60) Provisional application No. 60/182,434, filed on Feb. 15, 2000.
(60) Provisional application No. 60/204,386, filed on May 15, 2000.

(51) Int. Cl. G06F 15/16

(52) U.S. Cl. 709/232; 709/231

(57) ABSTRACT

A system and method are described for receiving content in data packets transmitted in repeating loops of the packets arranged in a given sequence. A client subscribes to receive the content from a server. The header of each packet identifies the total number of packets in the sequence, the packet number for the current packet, and the size of the packet. The client begins receiving the packets at any point in the transmission sequence and then uses this header information to set up an index for tracking the receipt of the entire sequence. The index is used in particular to identify any packets that are missing and have not been received. The client determines whether it is better to wait for a missing packet to reappear in the sequence or to specifically request the missing packet from the server.

### RELATED APPLICATIONS

This application is related to the following commonly owned patent applications, filed concurrently herewith, each of which applicaitons is hereby incorporated by reference herein in its entirety:

Application Ser. No. ______, titled “SYSTEM AND METHOD FOR MANAGING CONNECTIONS TO SERVERS DELIVERING MULTIMEDIA CONTENT,” attorney docket no. 4700/6.

### BACKGROUND OF THE INVENTION

The invention disclosed herein relates generally to techniques for distributing multimedia content across computer networks. More particularly, the present invention relates to an improved system and method for distributing content to clients whereby unnecessary transmission of request data is eliminated or greatly reduced, thereby allowing a richer interactive experience and maximizing the use of network bandwidth by both clients and servers.

In many current systems, the transferal of information between a server and client such as over the Internet requires the creation of sequential communication sessions. The client posts a request to the server for data and waits for the server to respond. The server's processing and transmission bandwidths are consumed servicing each client individually. The viewer at the client is put through a series of stop and go transactions as data is transferred between the server and the client.

Viewers prefer to experience a more continuous stream of information. In addition, clients need to be able to retrieve information without having to interrupt the server. There is thus a need for improved systems and methods for distributing media data requiring fewer server interruptions and providing a more continuous flow of data at lower bandwidth. As the following background demonstrates, existing systems partially address these problems. However, providing complex and rich media experiences at high levels of quality require additional improvements to existing technology.

Computer networks transfer data according to a variety of protocols, such as UDP (User Datagram Protocol) and TCP (Transport Control Protocol). According to the UDP protocol, the sending computer collects data into an array of memory referred to as a packet. IP address and port information is added to the head of the packet. The address is a numeric identifier that uniquely identifies a computer that is the intended recipient of the packet. A port is a numeric identifier that uniquely identifies a communications connection on the recipient device.

Once the data packet is addressed, it is transmitted from the sending device across a network via a hardware network adapter, where intermediary computers (e.g., routers) relay the packet to the appropriate port on the device with the appropriate unique IP address. When data is transmitted according to the UDP protocol, however, no attempt is made to inform the sender that the data has successfully arrived at the destination device. Moreover, there is neither feedback from the recipient regarding the quality of the transmission nor any guarantee that subsequent data sent out sequentially by the transmitting device will be received in the same sequence by the recipient.

According to the Transmission Control Protocol, or TCP, data is sent using UDP packets, but there is an underlying “handshake” between sender and recipient that ensures a suitable communications connection is available. Furthermore, additional data is added to each packet identifying its order in an overall transmission. After each packet is received, the receiving device transmits acknowledgment of the receipt to the sending device. This allows the sender to verify that each packet of data sent has been received, in the order it was sent, to the receiving device. Both the UDP and TCP protocols have their uses. For most purposes, the use of one protocol over the other is determined by the temporal nature of the data. Data can be viewed as being divided into two types, transient or persistent, based on the amount of time that the data is useful.

Transient data is data that is useful for relatively short periods of time. For example, a television transmits a video signal consisting of 30 frames of imagery each second. Thus, each frame is useful for 1/30^{th} of a second. For most applications, the loss of one frame would not diminish the utility of the overall stream of images. Persistent data, by contrast, is useful for much longer periods of time and must typically be transmitted completely and without errors. For example, a downloaded record of a bank transaction is a permanent change in the status of the account and is necessary to compute the overall account balance. Loosing a bank transaction or receiving a record of a transaction containing errors would have harmful side effects, such as inaccurately calculating the total balance of the account.

UDP is useful for the transmission of transient data, where the sender does not need to be held up verifying the receipt of each packet of data. In the above example, a television broadcaster would incur an enormous amount of overhead if it were required to verify that each frame of video transmitted has been successfully received by each of the millions of televisions tuned into the signal. Indeed, it is inconsequential to the individual television viewer that one or even a handful of frames have been dropped out of an entire transmission. TCP, conversely, is useful for the transmission of persistent data where the failure to receive every packet transmitted is of great consequence.

Each network on the Internet is uniquely identified with a numeric address. Each device within a network, in turn, is identified by an IP address that is comprised of a subnet address coupled with a unique device ID. According to version four of this standard (“IPv4”) an IP address is a 32-bit number that is represented by four “dot” separated values in the range from 0 through 255, e.g., 123.32.65.72. Each device is further configured with a subnet mask. The mask determines which bits of a device's IP address represent the subnet and which represent the device's ID. For example, a device with an IP address of 123.32.65.72 and a subnet mask of 255.255.255.0 has a subnet address of 123.32.65 and an ID of 72.

Each packet of data sent by a device, whether it is formatted according to the UDP or TCP protocols, has a header data field. The header is an array of bytes at the beginning of a packet that describe the data's destination, its origin, its size, etc. When a sender and recipient are both located within the same subnet, the recipient device's network hardware examines network traffic for packets tagged with its address. When a packet addressed to the recipient is identified, the network hardware will pass the received data off to the operating system's network services software for processing.

When a sender and recipient are located in different subnets, data is relayed from the originating subnet to the destination subnet primarily through the use of routers. While other physical transport methodologies are available, e.g., circuit switched transmission systems such as ATM (Asynchronous Transfer Mode), the majority of computer networks utilize packet switched hardware such as routers. A router is a device that interconnects two networks and contains multiple network hardware connections. Each network connection is associated with, and provides a connection to, a distinct subnet.

Two tasks are performed when a packet, destined for a subnet that is different from the subnet it is currently in, reaches a router within the current subnet. First, the router examines the subnets that it is connected to via its network hardware. If the router is connected to the packet's destination subnet, it forwards the packet to the router in the appropriate subnet. If the router is not directly connected to the packet's destination subnet, it queries other routers available on its existing connections to determine if any of them are directly connected to the destination subnet. When a router directly connected to the destination subnet is discovered, the packet is forwarded to it. Where a router connected to the destination subnet is not found, however, the router propagates the packet to a top level router that is strategically placed to allow access, either directly or through other top level routers, to the entire Internet. These top level routers are currently maintained by a registration authority under government oversight.

The transmission method described above is referred to as the unicast method of transmission, whereby a sender establishes a unique connection with each recipient. By utilizing a unicast model, the specific address of the receiving machine is placed in the packet header. Routers detect this address and forward the packet so that it ultimately reaches its intended recipient. This method, however, is not the most efficient means for distributing information simultaneously to multiple recipients. The transmission method that best facilitates broadcasting to many recipients simultaneously is multicasting.

Multicasting relies on the use of specialized routers referred to as multicast routers. These routers look only for data packets addressed to devices in the range of 224.0.0.0 through 239.255.255.255. This address range is specifically set aside for the purpose of facilitating multicast transmissions. Multicast routers retain an index of devices that wish to receive packets addressed to ports in this address range. Recipients wishing to receive multicast packets “subscribe” to a specific IP address and port within the multicast address space. The multicast routers respond to the subscription request and proceed to forward packets destined to the particular multicast address to clients who have subscribed to receive them.

Under the multicast model, the sender transmits packets to a single address, as opposed to the unicast model where the data is transmitted individually to each subscribing recipient. The multicast routers handle replication and distribution of packets to each subscribing client. The multicast model, like the broadcast model, can be conceptually viewed as a “one-to-many” connection and, therefore, must use the UDP protocol. UDP must be utilized because the TCP protocol requires a dialog between the sender and receiver that is not present in a multicast environment.

To support a richer media experience, as discussed above, clients may need to obtain multiple items of data at once. For example, a given rich multimedia presentation may consist of many different resources which the client needs to assemble, including transient and persistent data, and data receivable only through multicasting or only through unicasting in response to specific requests. In addition, clients may be able to assemble these resources in different sequences, but only if the downloading is optimized for this purpose. The need to make repeated requests to servers for the desired information creates heavy traffic and numerous interruptions which slow server operations and impose heavy bandwidth requirements.

There is thus a need for a system and method that improves downloading sequences and minimizes or eliminates unnecessary network communication.

### BRIEF SUMMARY OF THE INVENTION

It is an object of the present invention to solve the problems described above in existing content delivery systems.

It is another object of the present invention to provide more efficient retrieval of content from servers.

It is another object of the present invention to allow multiple clients to retrieve the same content from the same server while minimizing interruptions of the server delivering the content.

The above and other objects are achieved by a computer implemented method for receiving content data transmitted from a server in a sequence of packets, where the server repeatedly transmits the packets in sequence or loops through the sequence. The method involves, upon a client's receipt of a first packet from the server, deriving from the packet a number of the packet in the sequence and a total number of packets in the sequence. The server inserts this data into the header of the packet before transmission. The client then generates and stores an index having an entry for each of the packets in the sequence based upon the total number of packets in the sequence.

The client may further allocate a buffer in memory for storing the expected packets, with the size of the buffer being determined by multiplying the size of the first packet by the total number of packets. The client may determine the size of the first packet by reading such data from the header, if inserted there by the server, or measuring the packet. The allocated buffer space is exactly the required amount if the server broke the content into equal sized packets. Otherwise, the buffer represents approximately the amount of memory needed. Alternatively, if non-equal sized packets are used, the total data size of all packets may be stored in the header of each packet as well, so that a buffer with an appropriately allocated amount of space may be provided by the client.

The method further involves the client updating the index for each packet received subsequent to the first packet, by registering the received packet's number in the index. The client may further store the packet data in the allocated buffer space at the proper location in the sequence. The client uses the index to detect whether any subsequent packet is missing from the sequence of packets. This may be done on the fly, by detecting whenever a subsequent packet is received whether the prior packet just received precedes the current packet consecutively in the sequence, or may be done after the sequence has begun to repeat packets.

If a missing packet is detected, the client determines whether the first time required to retrieve the missing packet by waiting for the packet to be received in the repeating sequence is greater than a threshold time. If the first time is greater than the threshold time, the client requests the missing packet to be delivered from a server. If the first time does not exceed the threshold, the client waits for the sequence to loop around again to the missing packet, and then receives and stores the missing packet. The threshold time may be a predefined time set by a producer of the content or a server administrator and included in a software application executing on the client and performing this process, or may be computed as the time required to request and receive the missing packet from the server based, for example, on available bandwidth.

Objects of the invention are also achieved by a system for delivering content from a server to one or more clients such as over the Internet. The system includes a server, such as a multicast server, for transmitting an item of content in a sequence of packets, each packet containing a header storing a number of the packet in the sequence, and the packets being transmitted as repeating loops of the packets in sequence. The system also includes a client system for subscribing to the multicast server, receiving the transmitted packets, tracking the receipt of packets using the packet numbers, identifying any packets in the sequence which are missing based on the tracked packet numbers, and deciding whether to wait for any given missing packet to be received in the subsequent loop or request the missing packet from the server. The server transmits the missing packet in response to a request received from the client system. The server may include a packetized data source structure for decomposing the content into the sequence of packets.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting the configuration of hardware and software components, according to one embodiment of the present invention;

FIG. 2 is a flow diagram presenting the process of looping distribution of data, according to one embodiment of the present invention;

FIG. 3 is a flow diagram continuing the process of looping distribution of data, according to one embodiment of the present invention, and

FIG. 4 is a block diagram presenting the decomposition of a segment of data into discrete packets, distribution of the packets, and concatenation of the packets into the original data segment by the client, according to one embodiment of the present invention.

### DETAILED DESCRIPTION OF THE PREFERRED EMBODIMENTS

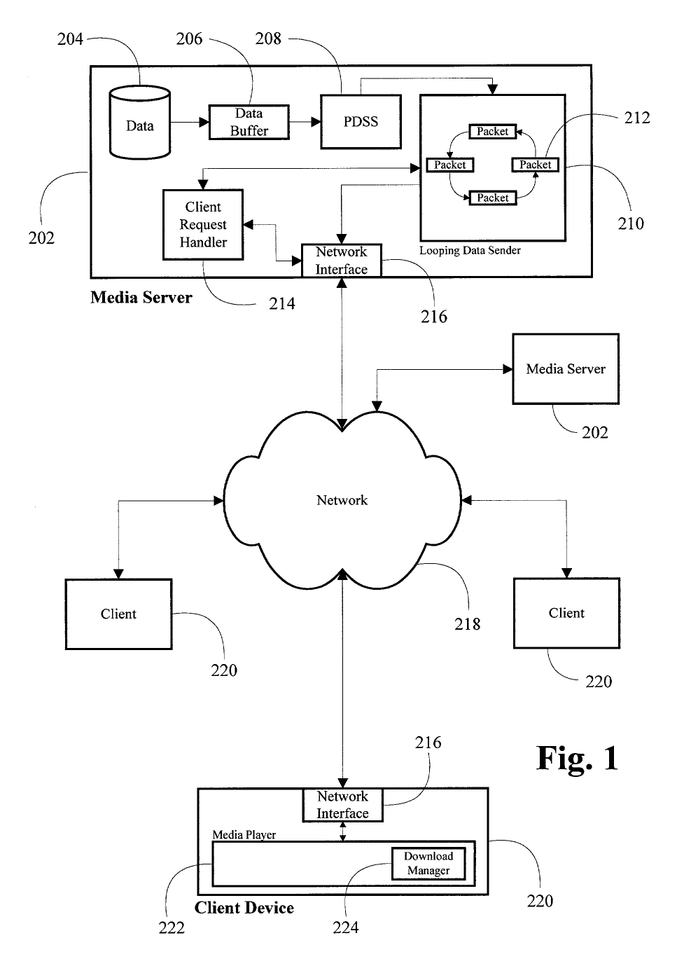

With reference to FIGS. 1-4, detailed embodiments of the present invention are now described. Referring to FIG. 1, a system of one preferred embodiment of the invention is implemented in a computer network environment 218 such as the Internet, an intranet, or other closed or organizational network. A number of clients 220 and servers 202 are connected to a network 218 by various means, such as network interface hardware 216. For example, if the network 218 is the Internet, the servers 202 may be web servers that receive requests for data from clients 220 via HTTP, retrieve the requested data, and deliver them to the client 220 over the network 218. The transfer may be according to TCP or UDP protocols, and data transmitted from the server 202 may be unicast to requesting clients or available via multicast to multiple clients simultaneously through the use of a multicast router.

In accordance with the invention, the server 202 contains several components or systems including a data source 204, a Packetized Data Source Structure 208, a Looping Data Sender 210, and a Client Request Handler 214. These components may be comprised of hardware and software elements, or may be implemented as software programs residing and executing on a general purpose computer and which cause the computer to perform the functions describe in greater detail below.

Data producers use the data source 204, such as a conventional database, to manage media content such as video, audio, graphics, or text content. The database 204 may be a relational database, an object-oriented database, a hybrid relational object oriented database, or a flat-file database. In other embodiments, the data store 204 is simply a persistent storage device, such as a fixed hard disk, with a file system managed by the server's OS. Data selected from the data store 204 for transmission is placed in a data buffer 206, which provides transient storage for data that is to be manipulated prior to transmission.

The Packetized Data Source Structure 208 is provided to retrieve data temporarily held within the buffer 206. The Packetized Data Source Structure 208 thus receives data retrieved from the data store 204 and held in the buffer 206. The Packetized Data Source Structure 208 takes a contiguous segment of the data as input and produces a plurality of discrete data packets 212. Each data packet 212 is tagged with identifying information including the packet's position or number in the overall sequence of packets, the total number of packets that comprise the contiguous portion of data that is to be sent to the client, and the number of bytes contained within the packet. The packets may be tagged with additional information required by a given communication protocol, hardware device, or software application requesting the data on the client device.

One or more Looping Data Senders 210 receive packets 212 generated by the Packetized Data Source Structure 208. The Looping Data Sender 210 takes each packet 212 and transmits it by way of an integrated or external network adapter 216 to clients 220 via a network 218. After the final packet 212 in the sequence is received and transmitted, the Looping Data Sender 210 begins re-transmitting the packets starting with the first packet in the sequence. In this manner, the Looping Data Sender continually “loops” through the transmission of the packets, allowing clients 220 to receive all packets regardless of the point in the sequence at which they began receiving the packets 212. As explained further below, this also allows clients 220 to receive any dropped or otherwise missing packets without having to interrupt the server 202 or waste bandwidth transmitting requests for re-transmission. The server 202 transmits packetized data via a network 218 to any client 220 requesting the data. In some instances such as through a multicast router, the server 202 multicasts the packets. The client 220 is equipped with an integrated or external network adapter 216 used to receive data packets from the network 218. The client has persistent and transient memory for storing received data packets, storing and executing application programs, and storing other resources. One application stored in persistent memory and executed in transient memory by the client is a Media Player 222, which is used for the playback of multiple types of media including, but not limited to, audio, video, and interactive content. The Media Player 222 application contains an integrated Download Manager 224. In alternative embodiments, the Download Manager 224 is a standalone software or hardware component accessed by executing applications, such as the Media Player 222. The Media Player 222 may have substantial additional functionality in coordinating and optimizing the retrieval of the content, such as the functions described in the commonly owned provisional and non-provisional patent applications listed above, all of which have been incorporated herein by reference.

The Media Player 222 issues requests for media packets 212 to the server 202. If the server 202 is multicasting the content, the client request takes the form of a subscription to the server 202. Packets are received across the network 218 via the client's network interface adapter 216. The Media Player 222 or other application requesting data from the server accepts and records receipt of packets in memory. Upon receipt of a duplicate packet, the client will stop receiving further packets, as the receipt of a duplicate packet is an indication that the packet sequence has looped around to the point at which the client first starting receiving packets and therefore the client should have received al the packets in the sequence. The client checks whether any packets in the sequence are missing and, if so, determines if the time to wait for the Looping Data Sender 210 to retransmit the packet is greater than a time threshold, such as the time needed to directly request and receive the missing packet or packets from the server, or a predefined threshold set by the content producer. If the time to wait for the packet to be received is greater than the threshold, the Download Manager 224 issues a request to the Client Request Handler 214. Upon receiving the request, the Client Request Handler 214 accesses the Looping Data Sender 210, duplicates the requested packet and transmits it to the client. The result is that clients are continually fed a stream of requested data and can recover missing packets by either simply awaiting retransmission of the packet or requesting it directly, whichever the client deems is most efficient given the bandwidth constraints of the client.

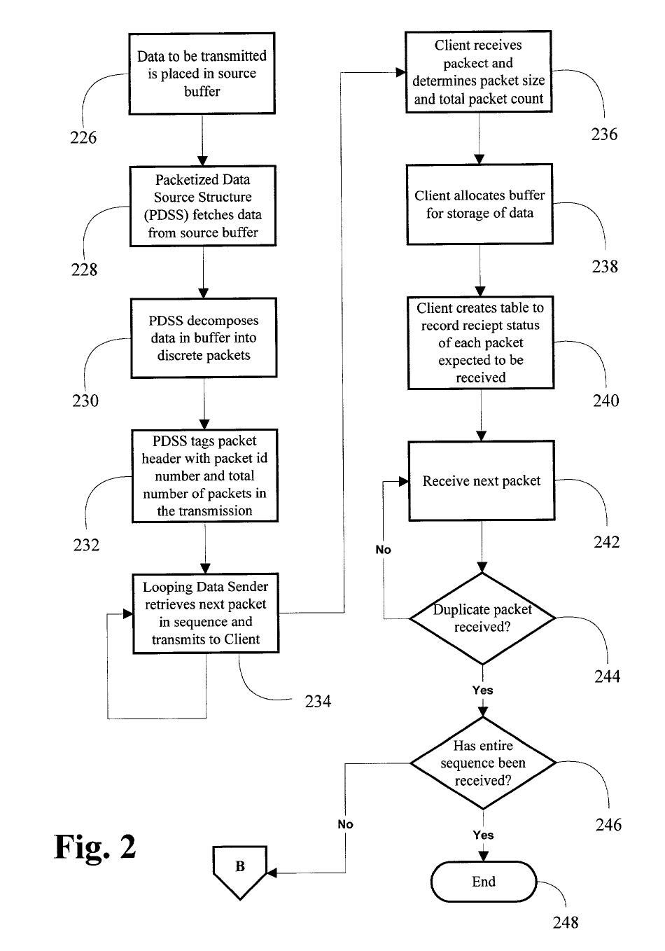

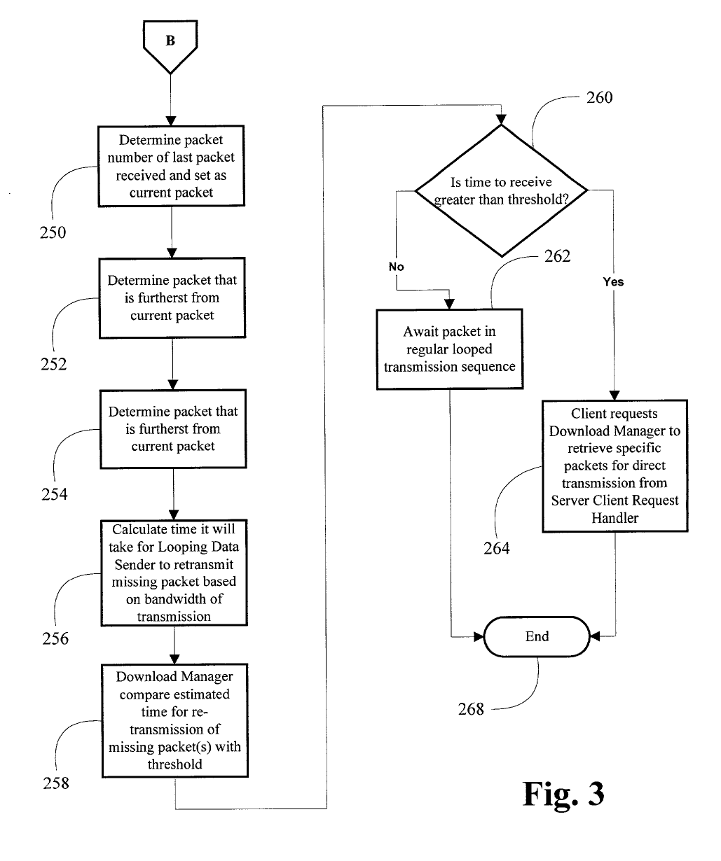

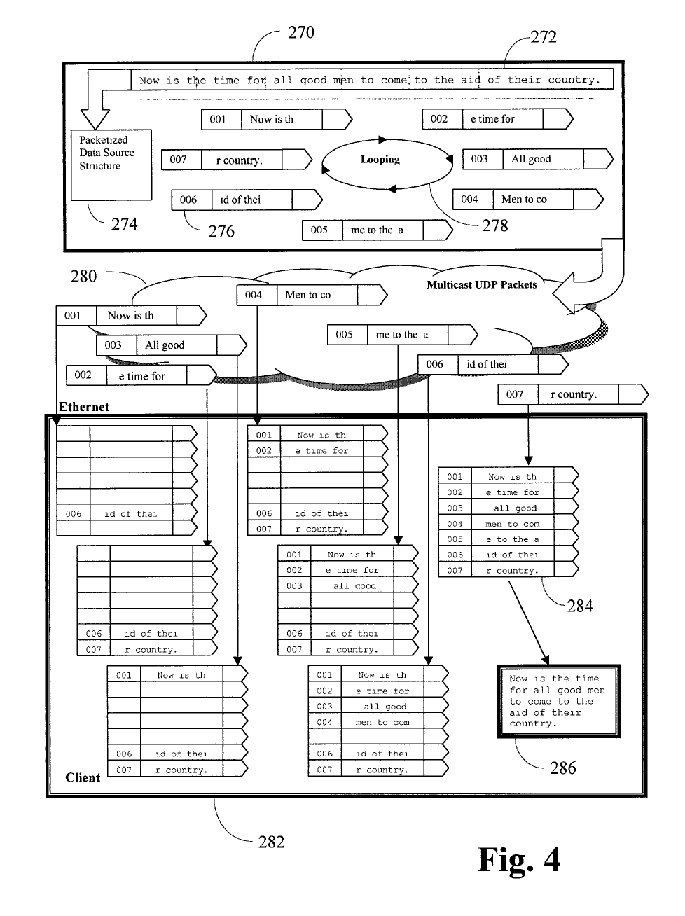

One embodiment of a process using the system of FIG. 1 is shown in FIGS. 2 and 3, and further illustrated by the example in FIG. 4. Referring to FIG. 2, data to be transmitted to clients is extracted from a data source and placed within a data buffer for temporary storage prior to distribution, step 226. A Packetized Data Source Structure periodically fetches data from the buffer as a single contiguous segment of data, step 228. The retrieved data is decomposed into a plurality of discrete data packets optimized for transmission across the type of network the computer executing the software is connected to, step 230. The packets may be of equal size to one another, or may vary slightly in size as desired to optimize them for transmission. Furthermore, the data may be of any type or format, due to the fact that the Packetized Data Source Structure breaks a large portion of data into a series of smaller pieces and makes no substantive analysis of the data it is decomposing.

Each packet consists of data and a header structure. The Packetized Data Source Structure tags each packet header with a unique packet identifier identifying the packet or piece of data being referenced, the number of bytes comprising the packet, followed by the actual bytes of data themselves, step 232. The Packetized Data Source Structure also labels each packet with the total number of packets in the sequence, allowing the client to determine how many packets are expected and which packets are missing from a transmission. The Packetized Data Source Structure holds the sequence of packets until transmission.

The packets are sent through one or more Looping Data Senders. The Looping Data Sender retrieves the next packet in the sequence held by the Packetized Data Source Structure and transmits it to the client, step 234. In embodiments where the client is receiving data via a multicast router, the Looping Data Sender transmits the packets to the multicast address, which handle duplication and transmission of the data to all subscribing clients. In Unicast embodiments, the Looping Data sender transmits data directly to the requesting client. The Looping data sender continues to fetch each data packet in the sequence and loops around to start transmission at the first packet in the sequence after all packets have been transmitted, step 234.

Clients receive data transmitted across a network from the Looping Data Sender. When the first packet is received, the client examines its header data to determine the packet size, the total packet count for the transmission, and the packet number of the first packet, step 236. The total transmission length can be determined by this data, e.g., by multiplying the size of the received packet by the total number of packets in the transmission. A buffer capable of storing at least the total transmission length is opened in memory on the client to temporarily store the packets, step 238, before being acted upon by a playback engine or other software by which the data is processed.

The client creates a table or index to record the reception status for each expected packet received, step 240. The index is assigned a number of entries equal to the total number of packets in the sequence. The number of the first packet is recorded as received in the index, and a pointer is moved in the index to the next expected packet in the sequence.

As the client receives data packets from the server, the reception status of each expected packet is recorded in the index created on the client device, step 242. The packet data is stored at the appropriate place in the buffer. The client continues to receive data packets and to record which packets have been received. The packet number extracted from the packet's header determines the storage location within the index where it will be placed. Packets continue to be received until a packet that is already recorded in the client index is received, step 244. When a duplicate packet has been received, a check is performed to determine if all expected packets have been received, e.g., the client examines its index to determine if it is complete or if index entries are missing, step 246. If all expected packets have been received, the transmission is complete and processing ends, step 248. The client now has the complete set of data and is free to manipulate it with the software application the data was intended for.

When transmitting data across a network, it is possible that one or more packets will be lost or “dropped” during transmission. Turning to FIG. 3, processing continues where an expected packet or packets forming the total transmission is not received. The client will determine the packet number of the last packet received and set it as the current packet, step 250. The client will also determine the packet identifier for the missing packet that is furthest from the current packet, step 252. Although a number of other packets may be missing, the client should only have to wait until the furthest such missing packet is retransmitted. Using this information as inputs, the client calculates the time it will take for the Looping Data Sender to retransmit the missing packet or packets based upon the bandwidth available for the transmission, step 256.

The Download Manager uses the calculated time that it will take to receive any missing packet if broadcast in its regular sequence from the Looping Data Sender and compares it with the time threshold, step 258. According to one embodiment, the threshold is a predetermined value set in the download manager or the software application that is expecting and will act upon the received data. Alternatively, in other embodiments, the threshold is dynamically set to the time the Download Manager calculates it will take to directly download the packet from the server, bypassing the normal sequence in which the Looping Data Sender transmits the packets. This calculation can be a function of the existing bandwidth currently available based, for example, on currently experienced transmission times.

The Download Manager takes one of two different actions based on whether the time to await transmission of the missing packet from the Looping Data Sender is greater than the threshold, step 260. If the time to await transmission of the missing packets by the Looping Data Sender is less than the threshold, the client simply waits until the Looping Data Sender retransmits the missing packet or packets and the routine ends, steps 262 and 268. Where the time to await retransmission is greater than the threshold, step 264, the client instructs the Download Manager to initiate a direct connection with the server via the Client Request Handler. The Download Manager transmits the index number of the missing packet or packets to the Client Request Handler, which, in turn, duplicates the desired packets from the Looping Data Sender and transmit them directly to the client. Upon receipt by the client, the packet's status is recorded in the index and processing is complete, step 268.

As an alternative, a missing packet may be detected by noting a skipped entry in the index following receipt of any given packet in the sequence. The download manager can then determine whether it should wait for the sequence to loop around again or specifically request the missing packet.

Because interaction required between the server and client to download data is eliminated or greatly reduced, download speeds are improved. Clients can “listen” to a server looping data and receive the required information without interrupting the server to get it. In this manner, bottlenecks such as transmitting a request for data and waiting for the server to respond are eliminated. Thus, each bandwidth purchaser takes full advantage of the specific bandwidth available.

FIG. 4 illustrates the process of the present invention as described herein. A server 270 retrieves a contiguous segment of data 272 from a data source and places it in a buffer. Data contained in the buffer, in this instance text data, is passed through a Packetized Data Source Structure 274 where the data is spilt into a plurality of packets and modified to include the packet's unique numeric id and data indicating the total number of packets in the sequence. A Looping Data Sender 278 retrieves each packet 276 and transmits it to a multicast address located on a network 280 for distribution to subscribing clients 282. When the Looping Data Sender transmits the final packet in the sequence, it begins retransmission with the first packet.

The client 282 subscribes to a multicast address to receive the data packets. The first packet is received and placed in an index 284 created on and stored by the client 282. According to this illustration, the client first receives packet number six in the sequence. Because each packet contains data indicating the total number of packets in the sequence, the index is adjusted accordingly. Since each packet is transmitted in sequence, the client receives packet seven, followed by packets one through five. After receiving packet five, the next packet is recognized as a duplicate and reception of additional packets is halted. The client checks to determine if all packets in the sequence have been received. When the entire sequence is received, the client will concatenate the separate packets into the same contiguous segment of data that is stored on the server 286.

In some embodiments, the system of the present invention is utilized with a media engine such as described in the commonly owned, above referenced provisional patent applications and pending non-provisional patent application Ser. No. ______ titled “SYSTEM AND METHOD FOR ACCOUNTING FOR VARIATIONS IN CLIENT CAPABILITIES IN THE DISTRIBUTION OF A MEDIA PRESENTATION.” Using the media engine and related tools, the producer determines a show to be produced, selects talent, and uses modeling or authoring tools to create a 3D version of a real set. This and related information is used by the producer to create a show graph. The show graph identifies the replaceable parts of the resources needed by the client to present the show, resources being identified by unique identifiers, thus allowing a producer to substitute new resources without altering the show graph itself. The placement of taps within the show graph define the bifurcation between the server and client as well as the bandwidth of the data transmissions.

The show graph allows the producer to define and select elements wanted for a show and arrange them as resource elements. These elements are added to a menu of choices in the show graph. The producer starts with a blank palette, identifies generators, renderers and filters such as from a producer pre-defined list, and lays them out and connects them so as to define the flow of data between them. The producer considers the bandwidth needed for each portion and places taps between them. A set of taps is laid out for each set of client parameters needed to do the broadcast. The show graph's layout determines what resources are available to the client, and how the server and client share filtering and rendering resources. In this system, the performance of the video distribution described herein is improved by more optimal assignment of resources.

In the context of this media delivery system, the system and process of the present invention as described herein works as follows. The client builds an index to receive show resources. After a connection has been made, a client request handler retrieves specific packets for a requesting client. Show resource packets are downloaded to the client beginning at the point when the client establishes its connection with the server. This need not be at the beginning of any transmission. Resources are received until the client logs a duplicate packet. The client inventories all packets received and either waits for the receipt of a missing packet by waiting for the looping mechanism to rebroadcast or by making a request to the download manager for a missing packet(s). The determination to wait or not is made by an algorithm measuring wait time against time required to request.

The looping data retrieval mechanism described herein thus improves the current model in at least three ways. First, it allows the client to receive transient data of a broadcast while also receiving persistent data. Transient data includes that portion of a broadcast that can change on every frame and persistent data includes that portion of the broadcast that remains the same through the length of a show. Second, the client need not interrupt the server to receive data. Third, the client can receive a show regardless of when a connection is made during the broadcast.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A computer implemented method for receiving content data transmitted from a server in a sequence of packets, the server repeatedly transmitting the packets in sequence, the method comprising:
upon receipt of a first packet from the server, deriving from the packet a number of the packet in the sequence and a total number of packets in the sequence;
generating and storing an index having an entry for each of the packets in the sequence based upon the total number of packets in the sequence;
updating the index for each packet received subsequent to the first packet;
detecting based on the index whether any subsequent packet is missing from the sequence of packets; and
if a missing packet is detected, determining whether the first time required to retrieve the missing packet by waiting for the packet to be received in the repeating sequence is greater than a threshold time and, if the first time is greater than the threshold time, requesting the missing packet to be delivered from a server.

2. The method of claim 1, wherein updating the index comprises deriving the packet number from the subsequent packet in the sequence and updating the entry in the index corresponding to the derived packet number.

3. The method of claim 2, wherein detecting whether any subsequent packet is missing comprises comparing the packet number for a currently received subsequent packet to the packet number for the packet received immediately prior to the currently received packet to determine whether the currently received packet number follows consecutively in the sequence from the immediately prior packet number.

4. The method of claim 2, comprising detecting a second receipt of the first packet based on the index.

5. The method of claim 4, comprising stopping further receipts of packets in the sequence upon detection of the second receipt of the first packet.

6. The method of claim 4, wherein detecting whether any subsequent packet is missing comprises checking the index for any missing packet number following detection of the second receipt of the first packet.

7. The method of claim 1, wherein deriving the packet number and total number of packets comprises retrieving the packet number and total number from a header of the packet.

8. The method of claim 1, comprising estimating based upon the first packet a total data size for the packets in the sequence and allocating a storage buffer for the packets in the sequence at least as large as the total data size.

9. The method of claim 8, wherein estimating the total data size comprises determining the size of the first packet and multiplying the first packet size by the total number of packets.

10. The method of claim 8, comprising storing content data in received packets in the allocated storage buffer in a sequence corresponding to the packet numbers.

11. The method of claim 1, wherein the threshold time comprises a time required to request and receive the missing packet from the server.

12. The method of claim 1, wherein determining whether the first time is greater than the threshold time comprises computing the first time based upon data representing available bandwidth.

13. The method of claim 1, wherein determining whether the first time is greater than the threshold time comprises computing the first time based upon measured time for receiving packets in the sequence.

14. The method of claim 1, comprising the client receiving packets by issuing a subscription request to a multicast server.

15. A system for delivering content from a server to one or more clients, the system comprising:
a multicast server for transmitting an item of content in a sequence of packets, each packet containing a header storing a number of the packet in the sequence, the packets being transmitted as repeating loops of the packets in sequence;
a client system for subscribing to the multicast server, receiving the transmitted packets, tracking the receipt of packets using the packet numbers, identifying any packets in the sequence which are missing based on the tracked packet numbers, and deciding whether to wait for any given missing packet to be received in the subsequent loop or request the missing packet from the server;
the multicast server transmitting the missing packet in response to a request received from the client system.

16. The system of claim 15, wherein the header for at least one packet contains data representing a total number of the packets in the sequence.

17. The system of claim 16, wherein the total number of packets is contained in the header for each packet in the sequence.

18. The system of claim 16, wherein the client system comprises a memory device storing an index of packet numbers, the index having a number of entries equal to the total number of packets in the sequence and being used by the client system in tracking.

19. The system of claim 16, wherein the client system comprises a memory device storing packets, the client system allocating space within the memory device for storage of the packets based on the total number of packets and a data size for at least one of the packets.

20. The system of claim 15, wherein the multicast server comprises a packetized data source structure for decomposing the content into the sequence of packets.

21. A computer readable medium storing program code for, when executed, causing a computer to perform a method for receiving content data transmitted from a server in a sequence of packets, the server repeatedly transmitting the packets in sequence, the method comprising:
upon receipt of a first packet from the server, deriving from the packet a number of the packet in the sequence and a total number of packets in the sequence;
generating and storing an index having an entry for each of the packets in the sequence based upon the total number of packets in the sequence;
updating the index for each packet received subsequent to the first packet;
detecting based on the index whether any subsequent packet is missing from the sequence of packets; and
if a missing packet is detected, determining whether the first time required to retrieve the missing packet by waiting for the packet to be received in the repeating sequence is greater than a threshold time and, if the first time is greater than the threshold time, requesting the missing packet to be delivered from a server.

22. A computer implemented method for transmitting content data from a server to one or more clients, the method comprising:
breaking the content data into a plurality of data packets arranged in a sequence;
inserting into a header of each data packet a total number of packets in the sequence, a number of the particular packet in the sequence, and data representing a size of the data in the particular data packet;
repeatedly transmitting the data packets in sequence; and
upon request from a client for transmission of a given data packet, transmitting the given data packet in response to the request without waiting for the packet to appear in sequence.
